(19) United States
(12) Patent Application Publication
(10) Pub. No.: US 2025/0143517 A1
(43) Pub. Date: May 8, 2025

(54) COOKING APPARATUS

(71) Applicant: FOODEASE LLC, Cheyenne, WY (US)

(72) Inventor: Sundeep Goud Malkapuram, Aurora, CO (US)

(21) Appl. No.: 18/918,885

(22) Filed: Oct. 17, 2024

Related U.S. Application Data
(60) Provisional application No. 63/579,026, filed on Aug. 27, 2023.

(51) Int. Cl. A47J 47/01; A47J 36/16; A47J 36/32; A47J 45/06

(52) U.S. Cl. CPC A47J 47/01; A47J 36/165; A47J 36/32; A47J 45/061; A47J 2202/00

(57) ABSTRACT

An automatic meal preparation appliance or cooking apparatus comprises an ingredient storage module operatively coupled with a base heating module. The ingredient storage module includes a plurality of cavities for storing ingredients. A rotatable ingredient dispensing disc is arranged between the ingredient storage module and base heating module. The disc comprises an opening for dispensing ingredients from the cavities into the base heating module. A motor module, housed within the ingredient storage module, controls the rotation of the disc to dispense the ingredients through the disc opening into a cooking pot associated with the base heating module, and also operates a tool for processing ingredients in the cooking pot.

### BACKGROUND

Cooking often requires adding particular ingredients at specific times and amounts to achieve desired flavor and texture. Ingredient dispensing cooking apparatuses are kitchen appliances for automatic meal preparation. Such devices may be designed to streamline a cooking process by integrating ingredient storage and dispensing into a vessel, and then cooking the dispensed ingredients in the vessel according to the cooking process, for example a recipe selected by a user. Such an automated system allows the addition of ingredients at precise times and minimizes process interruptions for efficient cooking. Such an automated system also offers the benefit of user convenience, in that the user is free to engage in other activities once the cooking process is initiated, and avoids user errors such as overcooking/burning food or inadvertently omitting/misusing ingredients.

However, such devices may be difficult to clean thoroughly and/or not dishwasher safe. Residual food particles may lead to hygiene issues. The mechanical components may be subject to wear and tear over time, potentially leading to malfunction or breakage. If components are made from low-quality material(s), they may not withstand high temperatures and frequent use associated with cooking. Some designs may be complex to assemble and disassemble, making them less user-friendly and/or cost effective. Some designs may also be relatively ineffective and/or difficult to operate.

Therefore, there is a need in the art for an improved cooking apparatus that is at least easy to clean and dishwasher-friendly. It would be further desirable if the cooking apparatus improved on one or more of the above-mentioned drawbacks observed in the art.

The foregoing examples of the related art and limitations therewith are intended to be illustrative and not exclusive. Other limitations will become apparent to those skilled in the art upon a reading of the specification and a study of the drawings.

### SUMMARY

The foregoing examples of the related art and limitations therewith are intended to be illustrative and not exclusive. Other limitations will become apparent to those skilled in the art upon a reading of the specification and a study of the drawings.

Proceeding from this background, a cooking apparatus is disclosed herein. The cooking apparatus comprises a base heating module and an ingredient storage module operatively mountable above the base heating module. The base module includes a heating element for heating a cooking pot. The storage module includes a plurality of compartments circumferentially arranged for holding ingredients. The storage module also includes a center cavity configured to accommodate a motor module therein. An ingredient dispensing disc is rotatable relative to the plurality of compartments. The dispensing disc has an opening for selectively dispensing ingredients from the plurality of compartments. For example, the dispensing disc may be rotatably connected to the storage module below the compartments. The cooking apparatus may further include a controller configured to execute a set of processor-executable instructions. The instructions may control the motor module and/or the heating element according to a selected cooking process. In some embodiments, the controller may be arranged in the base module.

According to one aspect, the motor module includes a first motor and a second motor. The first motor is configured to rotate the dispensing disc relative to the plurality of compartments. The second motor is configured to rotate a tool to process ingredients in the cooking pot. The first and second motors may be operated to rotate the dispensing disc and the tool, respectively, according to instructions from the controller.

According to another aspect, when the storage module is mounted on the base module, the cooking apparatus includes at least one handle assembly formed by a respective first handle portion of the storage module and a respective second handle portion of the base module. The at least one handle assembly may be used to mechanically couple the storage module to the base module. For example, the first and second handle portions may have respective mechanical connectors with interlocking elements configured to engage with each other to form the handle assembly. Additionally, the handle assembly may also form an electrical connection for transmitting power and/or instructions between the storage module and the base module. For example, the first and second handle portions may include respective electrical contact connectors configured to engage with each other to form the electrical connection between the base module and the storage module, when the storage module is mounted/coupled to the base module. In some embodiments, the electrical contact connectors are disposed on the mechanical connectors, such as the interlocking elements thereof, for example.

In some embodiments, the motor module may be removably disposed in the storage module. For example, the storage module and the motor module may include respective electrical contact connectors configured to engage with each other to form an electrical connection for transmitting power and/or instructions therebetween. In some embodiments, the motor module may include an extension member. The extension member may project laterally outward from an upper end section of the motor module. The first electrical contact connector of the motor module may be arranged in the extension member. The second electrical contact connector of the storage module may be arranged in an upper end section of the storage module between two adjacent compartments of the plurality of compartments. The motor module may be configured to receive power and/or instructions from the controller in the base module through the storage module, in embodiments where the base module and the storage module are electrically connected to one another.

In some embodiments, the cooking apparatus further includes a first sensor configured to detect rotation of the disc in relation to the plurality of compartments during the cooking process. The cooking apparatus may also include a second sensor configured to monitor a cooking temperature during the cooking process. The first and second sensors may be communicatively connected to the controller. The controller may control the motor module and the heating element based on data from the first and second sensors.

In some embodiments, the cooking pot may be removably supported on the base module above the heating element. The cooking pot may be thermally insulated from other portions of the base module.

In some embodiments, the plurality of compartments may be accessible from above for loading ingredients therein, and open downwardly toward the dispensing disc. Further, one or more compartments of the plurality of compartments may have an inverted V-shaped profile configured to prevent ingredients from adhering to surfaces of the one or more compartments.

In some embodiments, the dispensing disc may have a retention coupler configured to engage a receiving coupler of the storage module. The receiving coupler is rotatably disposed on the storage module. The receiving coupler and the retention coupler may have complementary threaded portions configured to form a screw connection.

In some embodiments, the receiving coupler may be fixed relative to an annular gear configured to engage a transmission gear driven by the first motor. The transmission gear may be laterally offset from a shaft extending from the motor module and operatively coupled to the second motor, with the shaft arranged in a passage through the annular gear. The tool may be removably attached to an end of the shaft opposite the motor module.

The following description is illustrative in nature and is not intended to be in any way limiting. In addition to the aforementioned illustrative aspects, embodiments, and features, further aspects, embodiments, and features will become apparent by reference to the following description and accompanying drawings. In the drawings, all figures are diagrammatic and therefore not necessarily to scale. Also in the drawings, like reference letters and numerals indicate corresponding parts in the various views.

### BRIEF DESCRIPTION OF THE DRAWINGS

The following description references the accompanying drawings where:

FIG. 1 is a perspective view of a cooking apparatus according to some embodiments of the disclosure.

FIG. 2 shows the cooking apparatus with a lid thereof removed.

FIG. 3 is an exploded side view of the cooking apparatus.

FIG. 4 is an exploded perspective view of the cooking apparatus.

FIG. 5A is a schematic diagram illustrating various components of the cooking apparatus.

FIG. 5B is a detail view of section 5B in FIG. 5A.

FIG. 5C is a detail view of section 5C in FIG. 5A.

FIG. 5D is a detail view of section 5D in FIG. 5A.

FIG. 6 is a perspective view of a base heating module with a cooking pot of the cooking apparatus.

FIG. 7 is a perspective view of an ingredient storage module with a motor module and liquid ingredient tank accessory of the cooking apparatus.

FIG. 8 is another perspective view of the ingredient storage module with an ingredient dispensing disc assembly and tool of the cooking apparatus.

FIG. 9 is a side view of the motor module and transmission assembly of the ingredient storage module.

FIG. 10 is a disassembled perspective view of the motor module and transmission assembly.

FIG. 11 is another disassembled perspective view of the motor module and transmission assembly.

FIG. 12 is an exploded side view of the motor module and transmission assembly, with various components omitted to show a configuration of a motor drivetrain.

FIG. 13 is an exploded perspective view of the motor module and transmission assembly, with various components omitted to show a configuration of a motor drivetrain.

Before further explanation, it is to be understood that the invention is not limited in application to the details of particular arrangements illustrated in the drawings, as the invention is capable of other embodiments. Embodiments and figures herein are to be considered illustrative rather than limiting.

### DETAILED DESCRIPTION

In the following description, for the purposes of explanation, various specific details are set forth in order to provide a thorough understanding of embodiments of the present disclosure. It will be apparent, however, that embodiments of the disclosure may be practiced without these specific details. Several features described hereafter can each be used independently of one another or with any combination of other features. An individual feature may not address all of the problems discussed above or might address only some of the problems discussed above. The problem(s) discussed above might not be fully addressed by any of the features described herein. Further, an individual feature may address another aspect or design unrelated to the problem(s) discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the invention as set forth.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the description or the claims, such terms are intended to be inclusive—in a manner similar to the term “comprising” as an open transition word—without precluding any additional or other elements.

Reference throughout this specification to “some embodiments” or “other embodiments” or “one embodiment” or “an embodiment” or “an instance” or “one instance” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only, and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, “substantially” means largely or considerably, but not necessarily wholly, or sufficiently to work for the intended purpose. The term “substantially” thus allows for minor, insignificant variations from an absolute or perfect state, dimension, measurement, result, or the like as would be expected by a person of ordinary skill in the art, but that do not appreciably affect overall performance.

Throughout the disclosure, “attachment means” include reversible and irreversible attachment elements such as screws, bolts, nuts, nails, rivets, adhesives, magnets, hook-and-loop fasteners, hook-and-slot fasteners, interlocking structures, snap-fits, threaded portions/elements, friction-grip releasable fasteners, fastening straps, clamps, clasps, and the like, but not limited thereto. The connection provided by the attachment means may provide a rigid connection that positionally locks the connected partners relative to one another, or if desired, allow for relative motion between the connected partners, as with hinges, linkages, swivels, sliding pairs and the like, but not limited thereto.

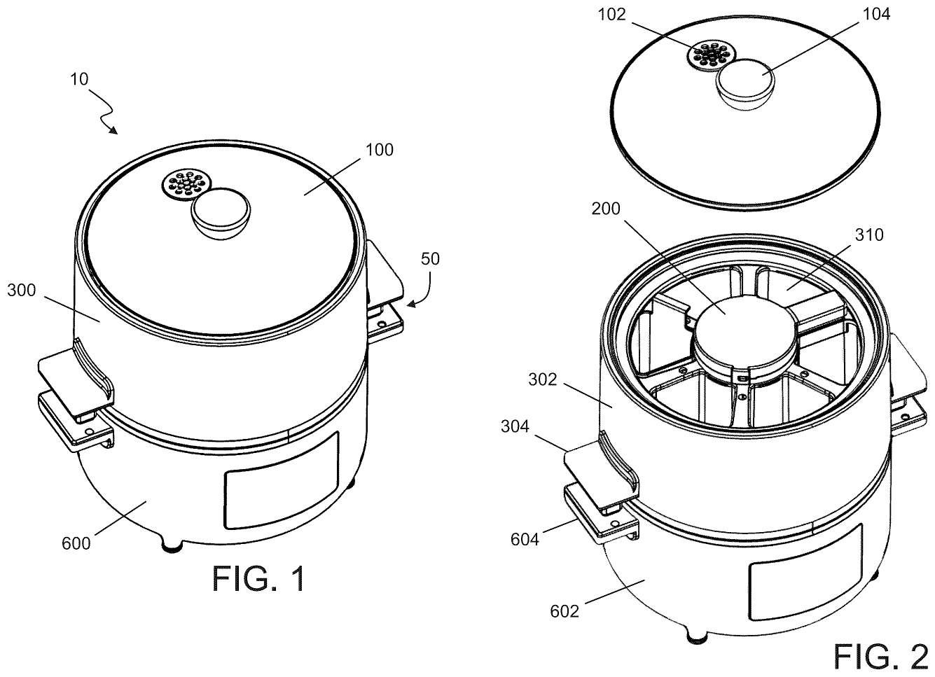

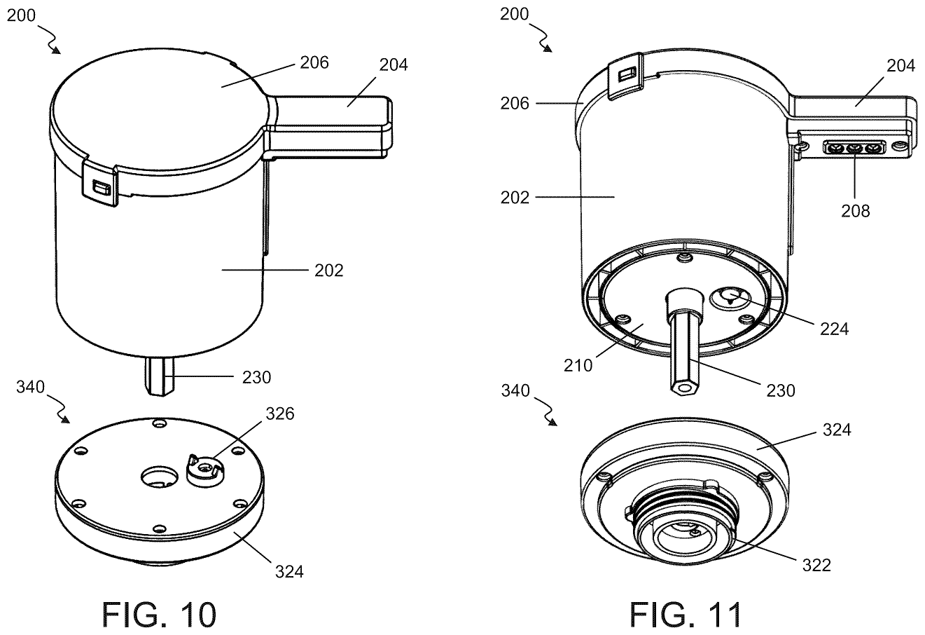

Various embodiments of the disclosure are now explained with reference to FIGS. 1-13.

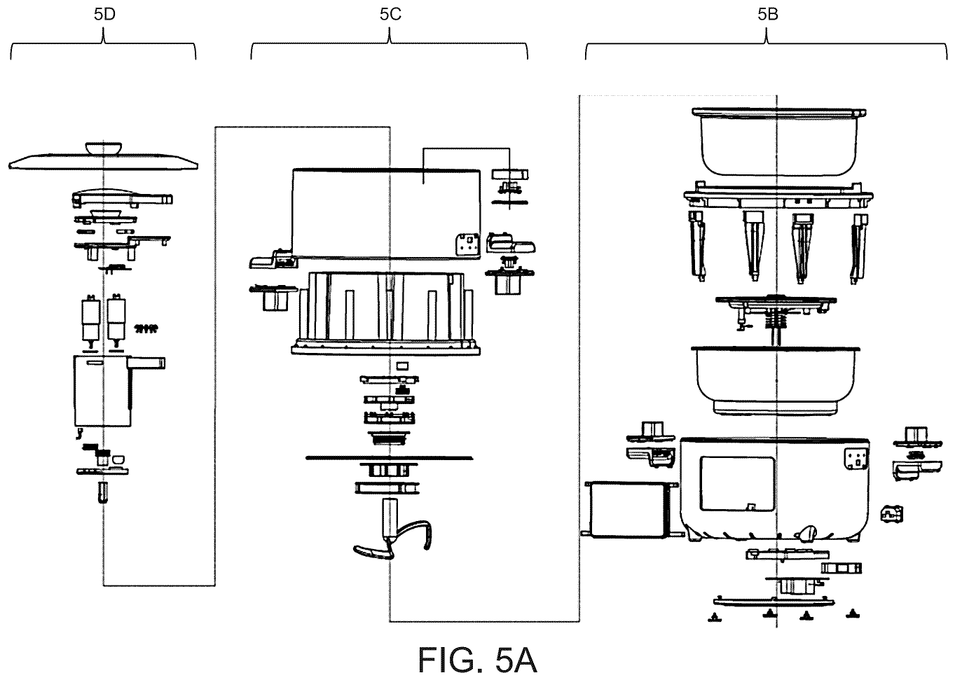

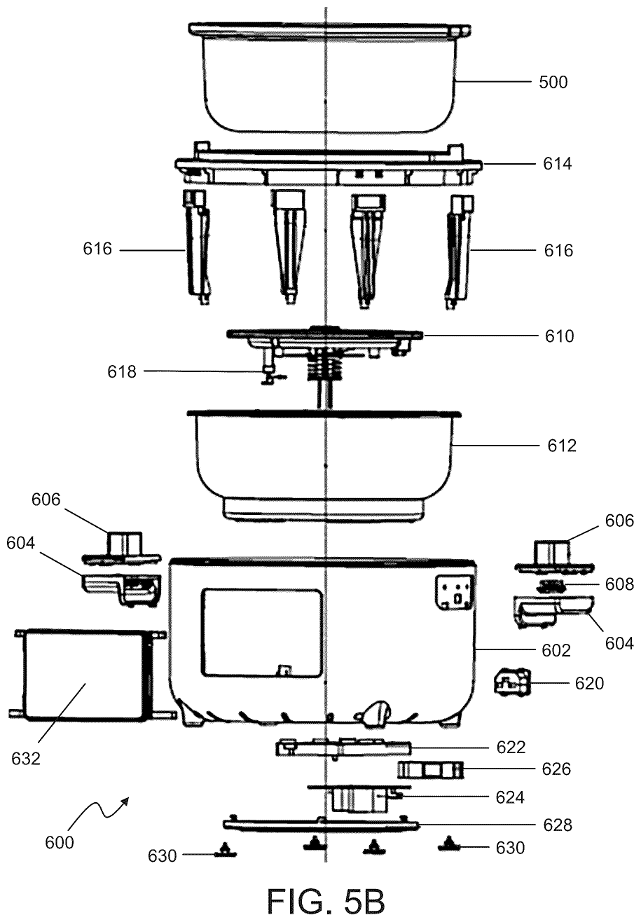

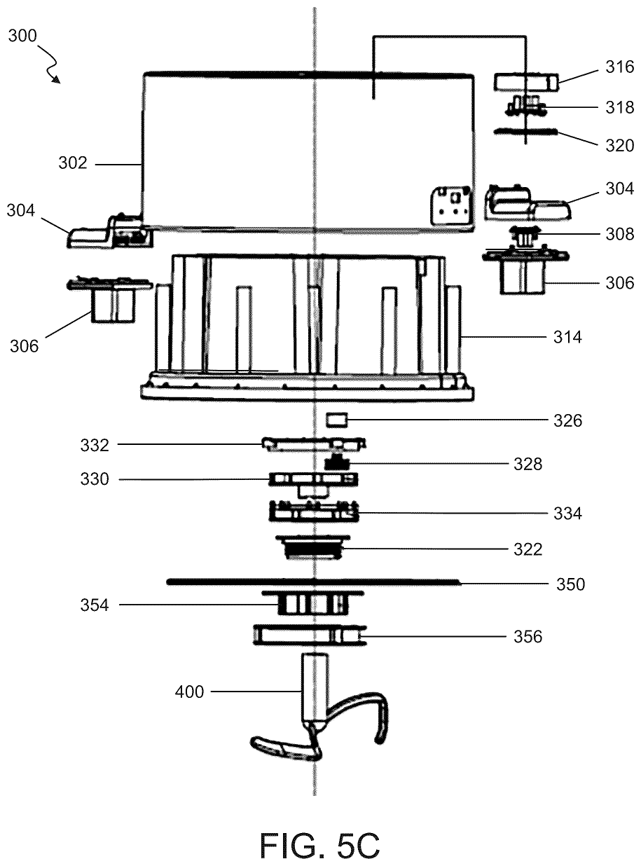

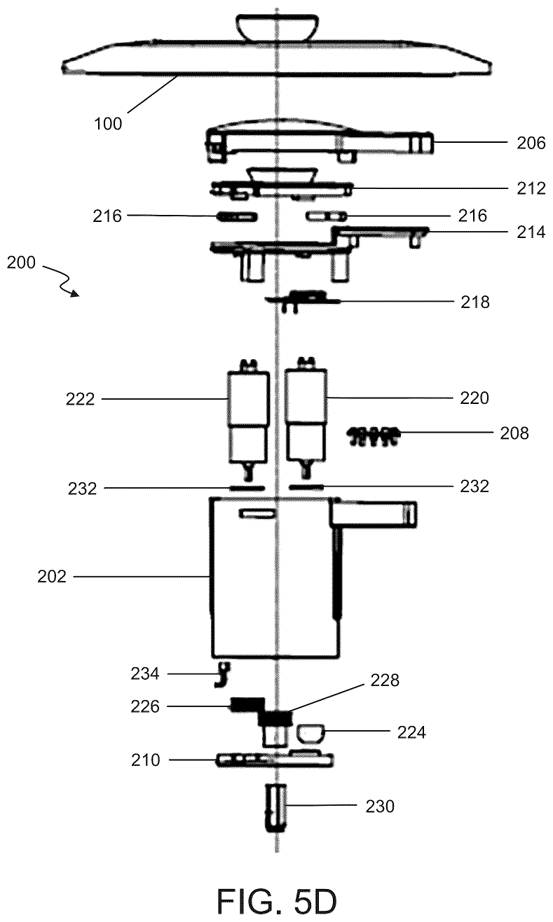

Referring to FIGS. 1 and 2, the cooking apparatus 10 includes a lid 100, an ingredient storage module 300, and a base heating module 600. The storage module 300 is removably/operatively mounted to the base module 600. The storage module 300 may be securely placed over the base module 600 to form an enclosure within which ingredients may be prepared, such as according to meal recipes for example. The storage module 300 is configured to hold ingredients therein, which may be controllably dispensed into the base module 600 for heating, cooking, mixing, etc. The storage module 300 may also be electrically connected to the base module 600. In some embodiments, the mechanical attachment and/or electrical connection between the storage module 300 and the base module 600 may be facilitated through a set of complementary projections. For example, the storage module 300 may carry at least one first or upper handle portion 304, the base module 600 may carry at least one second or lower handle portion 604, and when assembled, each set of complementary handle portions 304, 604 may form a respective handle assembly 50. The projections/handles 304, 604 may include mechanical connectors 306, 606 with interlocking elements that engage with each other. In other embodiments, the projections/handles 304, 604 may include other attachment means that engage with each other for secure locking. The projections/handles 304, 604 may be circumferentially disposed/arranged on the modules 300, 600. The cooking apparatus 10 may comprise one or more-typically two-handle assemblies 50 formed by such handle portions 304, 604. The projections/handles 304, 604 of at least one projection/handle assembly 50 may also have electrical connectors 308, 608 (see FIGS. 5B, 5C, 6, and 8) to establish an electrical connection between the storage module 300 and the base module 600. The electrical connection may be used to transmit power and/or information (e.g., control instructions, parameter data, etc.).

The lid 100 may enclose the top of the storage module 300 when arranged thereon. The lid 100 may comprise a circumferential seal configured to contact the abutment or support surfaces of the storage module 300, or vice versa. In some embodiments, the lid 100 may rest on the storage module 300 without using additional attachment means. In other embodiments, the lid 100 may be further secured to the storage module 300 using attachment means. In either case, the lid 100 is preferably removable (see FIG. 2) or otherwise openable, such as in the case of a hinged attachment for example, to allow access to components and ingredients in the storage module 300. For example, with the lid 100 removed or opened, a user may replenish ingredients or disassemble the cooking apparatus 10 for maintenance, cleaning, and the like. The lid 100, when placed to cover the storage module 300, may prevent ingredients from spilling out or being expelled from the cooking apparatus 10. The lid 100 is preferably made of transparent material, such as glass, to allow a user to view the ingredients in the storage module 300 or monitor a cooking process. The lid 100 may include an outlet or vent 102. The outlet 102 may enable steam, for example, generated from heating ingredients to exit the cooking apparatus 10, thereby preventing an overpressure buildup and/or maintaining an optimum pressure therein. The lid 100 may also comprise a lid handle 104 that provides a convenient grip for the user to manipulate and/or remove the lid 100 based on the requirements.

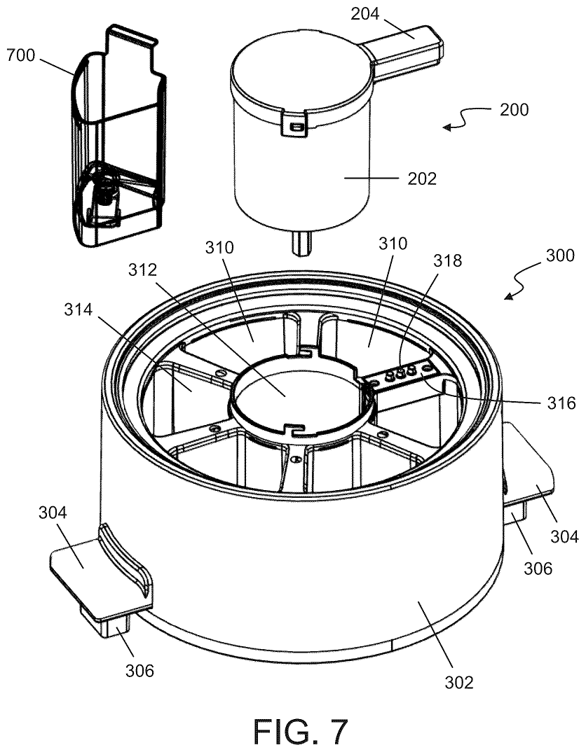

The storage module 300 is configured to store one or more ingredients therein. Examples of ingredients may include liquid ingredients, such as water, milk, oil, honey, pastes, curries, pickles, yolks, alcohol, beverages, juices, syrups, and the like, and solid ingredients, such as vegetables, meat, fruits, grains, seeds, spices, bread, powdered food, and the like, but not limited thereto. The ingredients may be placed within any of a plurality of compartments or cavities (see FIGS. 2 and 7) in the storage module 300. The storage module 300 may also be configured to house a motor module 200, which allows ingredients to be controllably dispensed into the base module 600. In this way, ingredients may be collected, premeasured, and readily available for a cooking process, thereby avoiding the need to fetch or measure ingredients during the actual cooking process. Premeasuring and storing the ingredients in the storage module 300 saves time and effort, especially for recipes requiring precise timing and sequential ingredient addition. By having all necessary ingredients in one place ready for use, the cooking process is more organized and streamlined. The storage module 300 may assist in managing complex recipes that require numerous ingredients added at different stages. The storage module 300 may automatically add ingredients in a particular order and at the appropriate stage according to a selected recipe being executed by the cooking apparatus 10.

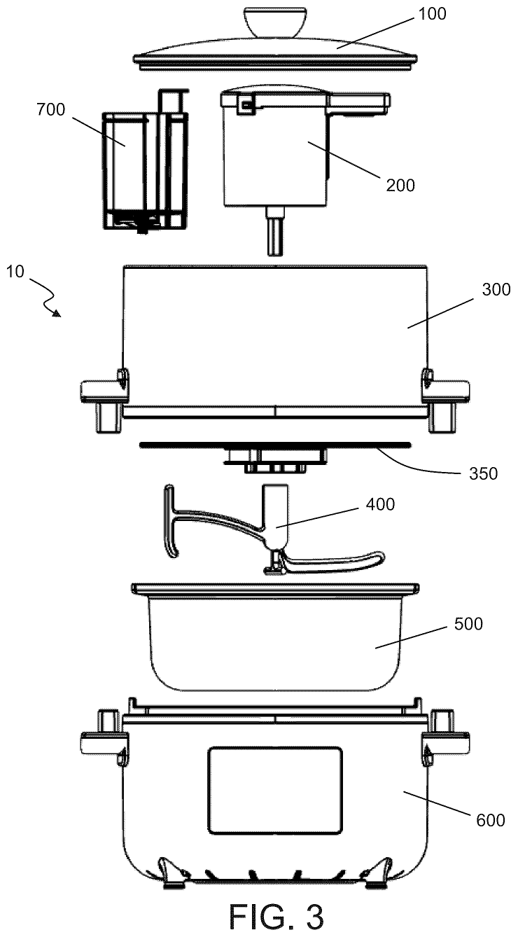

In some embodiments, the base heating module 600 is configured to cook the ingredients dispensed thereinto from the storage module 300. The base module 600 may cook the ingredients by heating the ingredients at a predetermined temperature, for example. The base module 600 may be configured to distribute heat evenly across a surface of a cooking pot 500 (see FIGS. 3, 4, and 6), resulting in consistent cooking and preventing hot spots that may cause burning or unevenly cooked food.

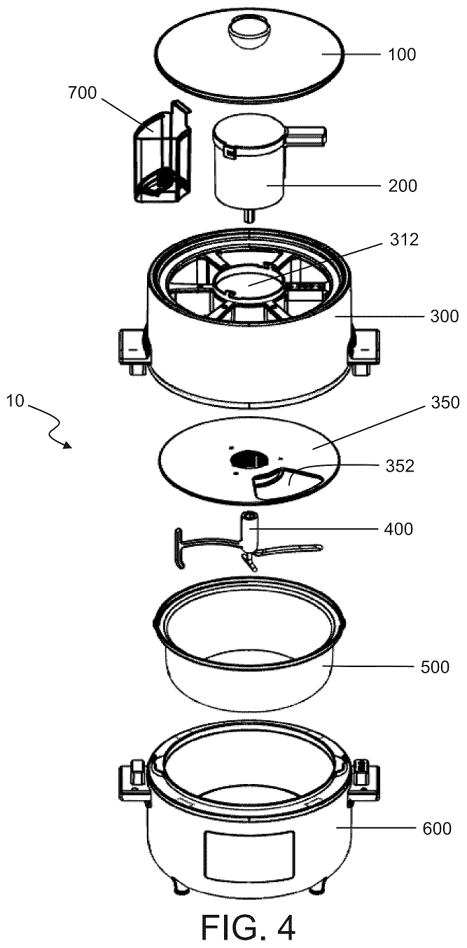

Referring to exploded views of the cooking apparatus 10 shown in FIGS. 3 and 4, the storage module 300 may include a center cavity 312 configured to accommodate the motor module 200 therein. The center cavity 312 may be a substantially cylindrical or prismatic cavity arranged in the middle or center of the storage module 300. The cavities 310, 312 may be defined by a main body 302 and/or an inner liner 314 of the storage module 300 (see FIGS. 5C, 7, and 8). The motor module 200 is preferably easily and readily removable from the center cavity 312. The motor module 200 may be removed from the storage module 300 to allow the storage module 300 to be handled separately for refrigeration of ingredients stored therein, or for washing/cleaning of the components of the cooking apparatus 10, for example.

In some embodiments, the motor module 200 is configured to controllably dispense ingredients in the storage module 300 into the cooking pot 500. In particular, the motor module 200 is operatively connectable to an ingredient dispensing disc 350. The disc 350 may be rotatably positioned between the storage module 300 and the base module 600 above the cooking pot 500. The disc 350 includes a hole/cutout portion 352 that allows ingredients in the cavities 310 above the disc opening 352 to be selectively dispensed into the cooking pot 500. The motor module 200 may be configured to rotate the disc 350 to position the disc opening 352 below the desired cavity 310 from which the ingredients are to be dispensed, thereby enabling the cooking apparatus 10 to controllably dispense the ingredients into the cooking pot 500 in the base heating module 600.

In some embodiments, the motor module 200 is configured to controllably process ingredients in the cooking pot 500. In particular, the motor module 200 is operatively connectable to a tool attachment 400. In the depicted example, the tool 400 is a stirrer or stirring element. The tool 400 may also be a mixer, beater, whisk, etc. depending on the desired action for ingredient processing. The motor module 200 may be configured to rotationally drive the tool 400, such as for mixing the ingredients in the cooking pot 500, for example. Depending on ingredient requirements, a tank 700 may be inserted into one or more cavities 310 for holding and controllably dispensing liquid ingredients.

FIG. 5A is a schematic diagram showing various components of the example cooking apparatus 10. FIGS. 5B, 5C, and 5D correspond to the sections 5B, 5C, and 5D, respectively, indicated in FIG. 5A to show additional detail of these sections.

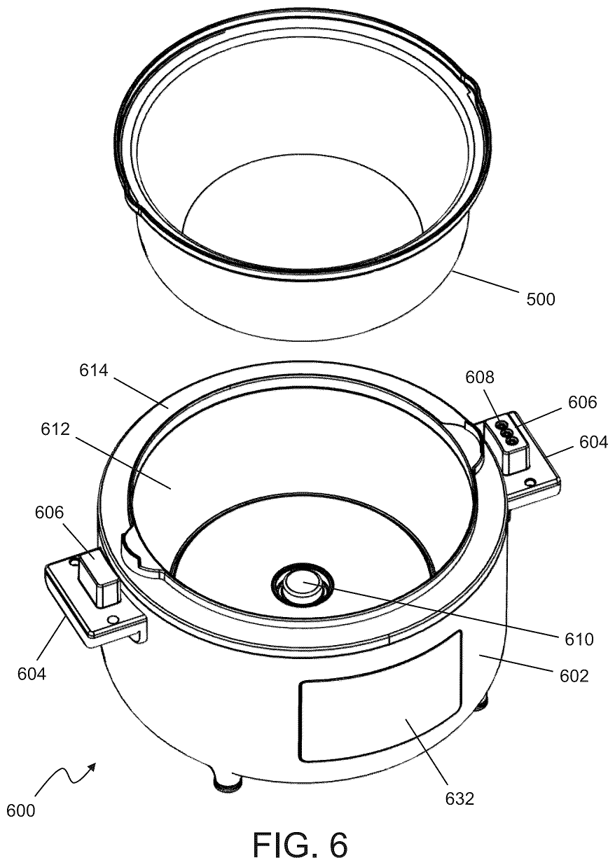

Referring to FIGS. 5B and 6, the base heating module 600 may be configured to support the cooking pot 500 and, among other functions, heat the ingredients dispensed thereinto. For example, the cooking pot 500 may be supported in a main body 602 of the base module 600 facing the storage module 300. In some embodiments, the cooking pot 500 may be a container, a holder or other receptacle. The receptacle may comprise a coating, such as an aluminum coating for example, to facilitate even heat distribution across a cooking surface, retain heat to efficiently maintain temperature, and/or improve the durability of the receptacle. Materials of the cooking pot 500 may be suitably adapted based on requirements and/or constraints of the particular use case.

In some embodiments, the base heating module 600 may comprise the main body 602, the one or more (second) handle portions 604 with the mechanical connector 606 and/or electrical connector 608, a heating element or unit 610, a thermal insulator bowl or receptacle 612, a base holding stand 614, one or more support legs 616, at least one sensor 618, an electrical socket 620, a controller box 622, a controller 624, a fan 626, a lower housing cover 628, one or more non-slip pads 630, and a user interface control panel 632.

The base stand 614 may be a substantially annular structure attached to the support legs 616. The base stand 614 and the support legs 616 may form a support structure or framework for mounting the cooking pot 500 in the base module 600 and spacing the cooking pot 500 from other components of the base module 600. In some embodiments, the base stand 614 and the support legs 616 may also support the thermal insulator bowl 612. The thermal insulator bowl 612 may be provided to protect the surrounding components from the high temperatures produced by the heating unit 610. For example, the thermal insulator bowl 612 is preferably positioned or placed between the heating unit 610 and the controller 624. The thermal insulator bowl 612 may contain the heat within an intended space or area, thereby improving efficiency and safety.

The heating unit 610 is configured to generate and distribute heat to the cooking pot 500. The heating unit 610 may convert electrical energy into thermal energy to heat the cooking pot 500. In some embodiments, the heating unit 610 may be arranged beneath the cooking pot 500 in the base module 600. While embodiments are described in the context of the unit 610 being configured to generate and distribute heat, in other embodiments, the unit 610 may be adapted to absorb heat from the ingredients. For example, the unit 610 may be implemented using a Peltier device configured to operably either generate heat or absorb heat from the ingredients in the cooking pot 500, based on the requirements and/or constraints of the particular use case.

The main body 602 may provide a primary housing structure of the base module 600, which encloses, supports, and protects the internal components of the base module 600. The main body 602 may provide an overall shape and framework for the base module 600. The socket 620 may provide a connection point for a power supply to the base module 600, enabling the heating unit 610 and other electrical components of the cooking apparatus 10 to receive power from external power sources (such as power grids, generators, external batteries, and the like). For example, the socket 620 may be arranged in the housing structure of the main body 602. In some embodiments, the lower housing cover 628 may close the base housing, providing an access point to the internal components of the base heating module 600, such as for assembly and maintenance for example. The lower housing cover 628 may comprise one or more outlets or vents to promote air circulation and/or heat dissipation. In some embodiments, the one or more non-slip pads 630 may be configured to ensure that the base module 600 remains stable and secure on various surfaces, preventing slipping and potential accidents during use. In some embodiments, the control panel 632 may provide a user interface for operating the base heating module 600, allowing users to view and control device settings, timers, and other functions or information.

The one or more handles 604 may be attached to an outer surface of the main body 602. Each handle 604 may be contoured to provide an ergonomic grip for handling and transporting the cooking apparatus 10. The handle 604 may be disposed circumferentially on the main body 602. The handle 604 may further include the (second) mechanical connector 606, which provides a point of attachment for securing the storage module 300 to the base module 600. In some embodiments, the mechanical connector 606 may comprise an interlocking element configured to mate with a corresponding interlocking element of the (first) mechanical connector 306 to securely couple the storage module 300 to the base module 600. For example, the mechanical connector 606 may comprise extrusions or projections extending from the handle portion 604. In some embodiments, the first connector 306 may be a body configured to fit into the second connector 606, and the second connector 606 may be a hollow structure (such as a shell) configured to receive the first connector 306 therein when aligned, or vice versa. In other embodiments, the handle portions 304, 604 may be configured with other attachment means to securely (but reversibly) couple the storage module 300 with the base module 600. Other embodiments may use other attachment means for mechanically coupling the storage module 300 to the base module 600.

In some embodiments, the base module 600 is configured to expose the electrical contacts/connectors 608, which electrically connect the base module 600 and the storage module 300, thereby facilitating the transfer of power and/or information (e.g., control instructions, parameter data, etc.) to various components of the cooking apparatus 10. The electrical connector/contacts 608 may be disposed on any surface of the base module 600 that comes into contact or proximity with the storage module 300. For example, the electrical connector/contacts 608 may be disposed on the handle 604, such as on the mechanical connector 606 thereof. In some embodiments, the base module 600 may include multiple second handle portions 604 configured to engage with corresponding first handle portions 304 on the storage module 300 to form respective handle assemblies 50, thereby mechanically coupling and/or electrically connecting the base module 600 and the storage module 300.

The controller box 622 may house and protect the controller 624 from heat, physical damage, dust, moisture, etc. In some embodiments, the fan 626 may be configured to dissipate heat and cool electronic components of the base module 600, such as the controller 624, thereby preventing overheating and promoting optimal performance of the cooking apparatus 10. For example, the fan 626 may be arranged to direct airflow in a direction away from the heating unit 610 toward an air outlet provided in the main body 602 and/or lower housing cover 628. The controller 624 may control the operation of the base heating module 600, including temperature regulation and safety features of the base heating module 600. The controller 624 may receive and process data from one or more sensors. For example, the sensors may be configured to detect temperature, pressure, humidity, water level, and/or other process parameters. The controller 624 may monitor, control, and adjust the operation of the cooking apparatus 10, including the heating unit 610 of the base module 600, based on such data. The sensor 618, as a temperature sensor, may be arranged in the space between the cooking pot 500 and the thermal insulator bowl 612.

The controller 624 may be configured to execute one or more processor-executable instructions, which may be stored on a computer readable medium, to control the motor module 200 and/or the heating unit 610. In some embodiments, the motor module 220 and/or the heating unit 610 may be controlled according to a selected cooking process. The processor-executable instructions may correspond to patterns of actuation of the motor module 200 and/or the heating unit 610, for dispensing ingredients from the storage module 300 to the cooking pot 500, mixing the ingredients therein, and/or heating the ingredients therein. In some embodiments, the controller 624 may be communicatively coupled with an operable software application configured on a computing device (not shown) through any or a combination of wired and/or wireless network connections and communication protocols such as, for example, Wireless-Fidelity (Wi-Fi), Bluetooth, Zigbee, optical fiber cables, data wire cable (e.g., Universal Serial Bus (USB)), and the like. Therefore, users may be able to select and cook recipes via the application, with or without viewing the corresponding steps of the cooking process for the selected recipe. In some embodiments, users may be able to create, share, and/or rate recipes via the application. The application may send operational instructions to the processor 624, which then executes the steps of the cooking process according to the instructions. For example, the application may locally store recipe instructions and/or retrieve recipe instructions via a network as needed. In some embodiments, the application may allow users to monitor and control the cooking process remotely, receiving notifications and updates on the computing device. In some embodiments, the application may connect users with technical support or cooking experts for troubleshooting and real-time cooking assistance. In some embodiments, the cooking apparatus 10 may comprise a built-in wireless charging dock for users to charge the computing device while using the application during the cooking process.

The computing device may be associated with users. The computing device may include smart devices operating in a networked environment, for example, an Internet of Things (IoT) system. The computing device may include, but is not limited to, smart phones, smart watches, smart sensors (e.g., mechanical, thermal, electrical, magnetic, etc.), personal computers, networked appliances, networked peripheral devices, networked lighting systems, communication devices, networked vehicle accessories, networked vehicular devices, smart accessories, tablets, smart televisions (TV), computers, smart security systems, smart home systems, and other devices for monitoring or interacting with or for users and/or entities, or any combination thereof.

A person of ordinary skill in the art will appreciate that the computing device may include, but is not limited to, intelligent, multi-nodal, network-connected devices, that can integrate seamlessly with each other and/or with a central server or a cloud-computing system, or any other device that is network-connected. A person of ordinary skill in the art will appreciate that the computing device may not be restricted to the mentioned devices and that various other devices may be used.

Referring to FIGS. 5C and 7, the storage module 300 may be configured to hold and dispense ingredients from the plurality of compartments or cavities 310. Further, the storage module 300 may include a center cavity 312 configured to accommodate the motor module 200 therein. In some embodiments, the storage module 300 may comprise the main body 302, the one or more (first) handle portions 304 with the mechanical connector 306 and/or electrical connector 308, the inner liner 314, a motor module coupler box 316, a motor module electrical connector 318, a coupler box base cover 320, a receiving coupler 322, a transmission gearbox 324, and the ingredient dispensing disc 350 with a retention coupler 354.

The main body 302 may provide a primary housing structure of the storage module 300, which houses and supports components of the storage module 300. The main body 302 may provide an overall shape and framework for the storage module 300. The one or more handles 304 may be attached to an outer surface of the main body 302. Each handle 304 may be contoured to provide an ergonomic grip for handling and transporting the cooking apparatus 10. The handle 304 may be disposed circumferentially on the main body 302. The handle 304 may further include the mechanical connector 306, which provides a point of attachment for securely coupling the storage module 300 to the base module 600 as described above. Other embodiments may use other attachment means for mechanically coupling the storage module 300 to the base module 600.

In some embodiments, the storage module 300 may be electrically connected to the base module 600. For example, the storage module may include a first electrical connector 308, and the base module 600 may include a corresponding second electrical connector 608. When coupled, the electrical connectors 308, 608 form an electrical connection between the modules 300, 600. The electrical connection may transmit power and/or information (e.g., control instructions, parameter data, etc.). In some embodiments, the electrical connectors 308, 608 may be provided as a complementary set of electrical contacts, such as a 2-pin, 3-pin, or 5-pin connector for example. In some embodiments, the electrical contacts of the storage module 300 may be arranged on a surface thereof which comes into contact or proximity with the base module 600. In some embodiments, the electrical contact connectors 308, 608 of the modules 300, 600 may be disposed on a complementary pair of the handle portions 304, 604, such as on the mechanical connectors 306, 608 thereof. In such embodiments, when the storage module 300 and the base module 600 are mechanically coupled using the mechanical connectors 306, 606, the electrical contacts may become engaged to provide electrical connectivity therebetween. Further, in such embodiments, since the electrical contacts are placed on the mechanical connectors 306, 606, decoupling or disassembling the storage module 300 from the base module 600 also breaks the electrical connection therebetween, thereby cutting power to electrical components of the storage module 300 (such as the motor module 200 driving the disc 350 and/or tool 400). This acts as a safety mechanism in that the disc 350 and tool 400 cannot be accessed by users while under power. Breaking of the electrical connection may also trigger the controller 624 to automatically shut down the operation of other components of the cooking apparatus 10 (such as the heating element 610) as an additional safety mechanism.

In some embodiments, the storage module 300 may also be electrically connected to the motor module 200. For example, the motor module 200 may include a first electrical connector 208, and the storage module 300 may include a corresponding second electrical connector 318. When coupled, the connectors 208, 318 form an electrical connection between the motor module 200 and the storage module 300. The electrical connection may transmit power and/or information (e.g., control instructions, parameter data, etc.). In some embodiments, the electrical connectors 208, 318 may be provided as a complementary set of electrical contacts, such as a 2-pin, 3-pin, or 5-pin connector for example. In some embodiments, the motor module 200 may include an extension member 204 projecting therefrom. The extension member 204 may carry the electrical connector 208 of the motor module 200 for coupling with the corresponding electrical connector 318 of the storage module 300. The electrical connector 318 of the storage module 300 may be mounted in a coupler box 316. The coupler box 316 may be closed by a coupler box base 320. For example, the extension member 204 may project laterally outward from an upper end section of the motor module 200, with the first electrical connector 208 being arranged in the extension member 204, and with the second electrical connector 318 being arranged in an upper end section of the ingredient storage module 300 between two adjacent ingredient cavities 310.

The electrical connection may be used to supply power to the motor module 200 from a power source connected to the storage module 300, such as through the base module 600. For example, power from a battery or external power source connected to the base module 600 may be conveyed via the storage module 300, for example through the electrical connectors 308, 608 of the handles 304, 604, to the motor module 200 through the electrical connectors 208, 318. In some embodiments, the electrical connections between the base module 600 and the motor module 200 through the storage module 300 may also be used for enabling the controller 624 to control the operation of the motor module 200 (such as rotational direction, frequency, torque, and/or speed of either the disc 350 or the tool 400, based on the requirements/constraints of the particular use case). While embodiments describe the controller 624 being placed in the base module 600, it may be appreciated by those skilled in the art that the cooking apparatus 10 may be suitably adapted to place the controller 624 within any module or component thereof.

As stated, the storage module 300 may include multiple cavities 310 to hold ingredients. In some embodiments, the plurality of cavities 310 may be disposed/arranged circumferentially in the storage module 300. The cavities 310 may be formed by the inner liner 314, or by the inner liner 314 and inner circumferential surfaces of the main body 302 of the storage module 300. In some embodiments, the inner liner 314 may have a radial pattern (i.e., having radial and/or rotational symmetry). For example, the inner liner 314 may have a spoked wheel-or sunburst-shaped cross-sectional profile. In some embodiments, the inner surfaces, such as those of the inner liner 314, defining one or more cavities 310 may be contoured with an inclination such that the cavity 310 has a substantially inverted V-shaped profile. In such embodiments, the inverted V-shaped profile may help prevent ingredients from sticking/adhering to the inner surfaces of the cavities 310 and/or clogging the disc opening 352. In some embodiments, the inner liner 314 may line an interior of the storage module 300, protecting the stored ingredients and ensuring that the stored ingredients remain uncontaminated. The inner liner 314 may also aid in smooth dispensing of the ingredients.

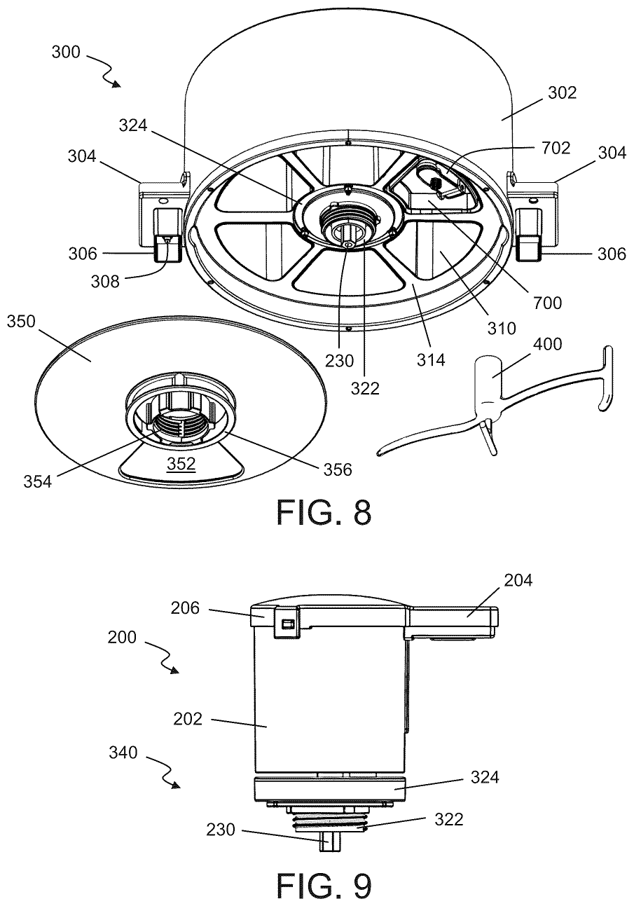

In some embodiments, the motor module 200 may be affixed with the tool attachment 400. The tool 400 may be drivingly connected to the motor module 200 using attachment means. In some embodiments, the tool attachment 400 may be removable, and replaceable with other tool attachments, which may then be actuatable by the motor module 200. Preferably, the tool 400 is magnetically mounted to allow various tools to be quickly and easily switched. The tool 400 may be connected to the motor module 200 via a shaft 230 (see FIGS. 8-13). While embodiments are described in the context of the tool attachment 400 being a tool adapted for stirring, it may be appreciated by those skilled in the art that the tool attachment may be any tool adapted for beating, whisking, mixing, grinding, chopping, and the like.

In some embodiments, the motor module 200 is configured to controllably dispense the ingredients in the cavities 310 based on instructions from the controller 624, for example according to steps of a recipe. The motor module 200 may be configured to controllably rotate the disc 350 with respect to the storage module 300, to dispense the ingredients into the cooking pot 500 below the storage module 300.

Referring to FIGS. 5C and 8, the dispensing disc 350 may be rotatably configured below the storage module 300. The disc 350 may be operatively connected to and driven by the motor module 200. In some embodiments, the disc 350 may be configured to hold and/or support the ingredients in the cavities 310 thereover. The disc 350 is preferably made of transparent material, such as glass, allowing users to monitor the cooking progress. In some embodiments, the disc 350 may be assigned a numbering system (0, 1, 2, 3, 4, 5, etc.) to indicate the position of the disc 350 with respect to the cavities 310. The disc 350 may automatically adjust to a default or zeroth position after each use, such that the positional orientation of the disc 350, and thus also the ingredient dispensing disc opening 352, is reset for subsequent uses. This numbering system may also be utilized in the executable application, showing users how much or which ingredient to place in each cavity 310, or users may tell the application the cavities 310 in which they placed certain ingredients and the application may adapt the cooking method accordingly. At least one sensor 234 may track the relative position of the rotating disc 350 as described below.

In some embodiments, the receiving coupler 322 may secure the disc 350 with respect to the motor module 200, thereby allowing the motor module 200 to rotate the disc 350. The receiving coupler 322 may be coupled to a gearbox 324 of the storage module 300 associated with the motor module 200 (see FIGS. 8-13). The receiving coupler 322 may include a threaded extension portion configured to mate with a corresponding thread of the retention coupler 354, and thereby secure the disc 350 between the receiving coupler 322 and the retention coupler 354. The retention coupler 354 may be fixed to the disc 350. In addition to the retention coupler 354, the disc 350 may have a handle 356 providing a grip for users. In this way, the disc 350 may be provided as an ingredient dispensing disc assembly with the retention coupler 354 and/or the handle 356. The disc 350, or disc assembly 350, is preferably removably attachable to the storage module 300, such as by screwing (or unscrewing) the retention coupler 354 to (or from) the receiving coupler 322 for example. Other attachment means may also be used for this removable attachment. The removable attachment allows users to remove the disc 350 from the storage module 300, such as for cleaning and/or maintenance for example.

The plurality of compartments or cavities 310 may be accessible from above for loading ingredients therein, and open downwardly toward the dispensing disc 350. In some embodiments, ingredients in the cavities 310 may be supported on/over an upper surface/portion of the disc 350, which may prevent the ingredients in the cavities 310 from falling into the cooking pot 500. The motor module 200 may be configured to controllably rotate the disc 350, such that the opening 352 of the disc 350 is moved below the cavity 310 holding ingredients to be dispensed. Since ingredients in the cavity 310 may no longer be supported on a surface/portion of the disc 350 in this position, the ingredients in such cavities 310 may fall into the cooking pot 500 through the disc opening 352.

In some embodiments, the cooking apparatus 10 may be provided with at least one liquid ingredient tank 700 (see FIGS. 3, 4, and 7). The tank 700 may enable the storage module 300 to hold liquid ingredients. The tank 700 may include an orifice at the bottom to allow for controlled release of the liquid ingredient into the cooking pot 500. The tank 700 may be configured to be inserted into one or more cavities 310. In some embodiments, the tank 700 may include a circumferential seal for a secure fit of the tank 700 into the cavities 310. When the motor module 200 rotates the disc 350 and moves the disc opening 352 below the cavity 310 in which the tank 700 is placed, the liquid ingredient in the tank 700 may be dispensed into the cooking pot 500 through the orifice. For example, the tank 700 may have a spout 702 on a lower portion thereof (see FIG. 8). The spout 702 may include a dispensing mechanism where a lid portion is mounted under the tank 700 with a hinge and carries a spring configured to act against an upper surface/portion of the disc 350 to upwardly bias the lid portion into a closed position sealing the orifice of the tank 700 in a liquid-tight manner (such as with a ring seal provided at the interface between the lid portion and a lower surface/portion of the tank 700 surrounding the orifice for example), and when the disc opening 352 is positioned underneath the tank 700 with the lid portion no longer supported on the disc 350 via the spring, the lid portion may swing down into an open position thereby allowing the liquid ingredient to flow through the tank orifice into the cooking pot 500.

As stated, the motor module 200 may be configured to controllably rotate the disc 350 to dispense the ingredients into the cooking pot 500. Further, the motor module 200 may be configured to rotate/actuate the tool 400 attached thereto. Preferably, the motor module 200 is configured to perform both functions independently and/or simultaneously.

Referring to FIGS. 8 to 13, the motor module 200 may include a first motor assembly and a second motor assembly configured to controllably rotate/actuate the disc 350 and the tool 400, respectively. In some embodiments, the first and second motor assemblies may be configured to operate independently of each other. The motor module 200 may comprise a main body 202, which may provide a primary housing structure for internal components of the motor module 200. The main body 202 may form an enclosure for the internal components of the first and the second motor assemblies when an upper cover 206 is placed on a first end (such as top-side end) of the main body 202 and a lower cover 210 is placed on a second end (such as bottom-side end) of the main body 202. This enclosure may provide structural support for the internal components of the motor module 200 and shield them from physical damage and environmental factors. The motor module 200 may comprise one or more additional structural support and/or housing components such as the outer hull partition wall 212 and the inner hull partition wall 214. In some embodiments, the main body 202, the upper cover 206, the lower cover 210, the outer hull partition wall 212, and/or the inner hull partition wall 214 may be configured to provide a tight seal with one another, at least to the extent such parts interface with each other as the case may be in a particular design of the motor module 200, to protect the internal components of the motor module 200 against the ingress of dust, moisture, food particles, etc., which could negatively affect mechanical and/or electrical functions. In some embodiments, assembly clasps 216 may be used to assemble components of the motor module 200 at predetermined positions.

In some embodiments, the extension member 204 may be configured to extend outward away from the main body 202. The extension member 204 may be formed from any one of, or any combination of, the main body 202, the upper cover 206, the lower cover 210, the outer hull partition wall 212, and/or the inner hull partition wall 214. In other embodiments, the extension member 204 may be provided as a separate part of the motor module 200 attached thereto. The extension member 204 may carry the electrical connector 208 for establishing an electrical connection with the electrical connector 318 of the storage module 300. In other embodiments, such as with no extension member 204 for example, the electrical connector 208 may be disposed on a lower surface/portion of the motor module 200 and interface with the electrical connector 318 within the center cavity 312, such as at a bottom surface or sidewall of the center cavity 312 for example. Although the main body 202 is shown to have a substantially cylindrical geometry, those skilled in the art will appreciate that the main body 202 may be suitably adapted to have any other shape to correspond to the shape of the center cavity 312, which may be adapted to have a prismatic shape, for example.

The motor module 200 may be configured to independently drive the disc 350 and tool attachment 400 using separate drivetrains. In some embodiments, the motor module 200 may be configured to rotate the disc 350 using the first motor assembly, which may interface with the disc 350 through the receiving coupler 322. The first motor assembly may comprise a first motor 220 operatively engaging a transmission assembly 340 of the storage module 300. The transmission assembly 340 may include the receiving coupler 322 and the gearbox 324. The disc 350 may be mounted to the receiving coupler 322. The second motor assembly may comprise a second motor 222 operatively engaging the shaft 230. The tool 400 may be mounted to the shaft 230.

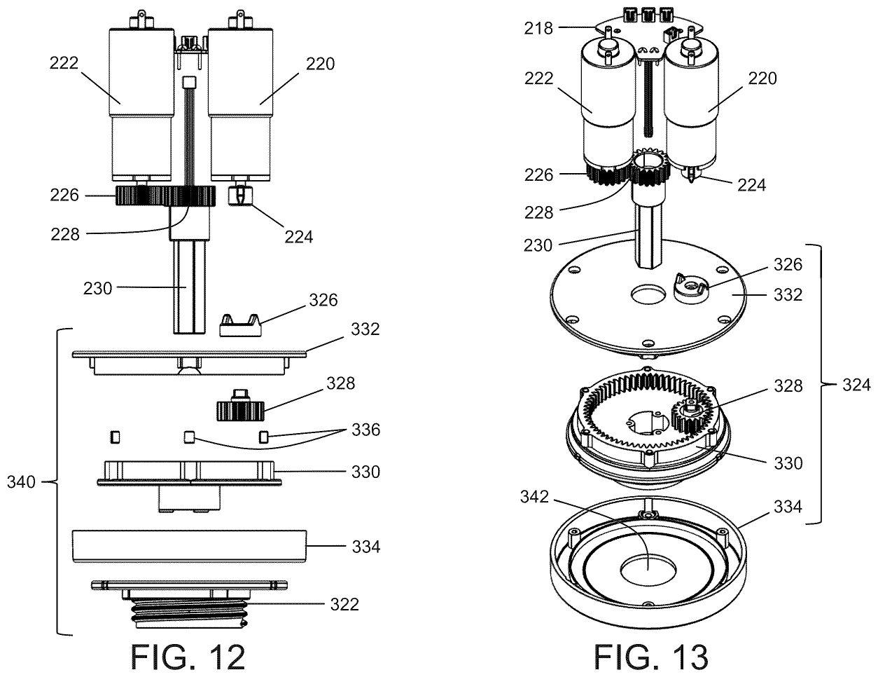

FIGS. 12 and 13 illustrate further details of the drivetrains. The first motor 220 is connected to the receiving coupler 322 through the gearbox 324. In some embodiments, a first coupling head 224 is attached to the rotor shaft of the first motor 220. The first coupling head 224 may be configured to interface with a corresponding second coupling head 326 of the gearbox 324 in a shaft-locked manner. The coupling heads 224, 326 may also be operatively coupled in a detachable and reconnectable manner, such as with axially extending teeth/projections for example, particularly in embodiments where the motor module 200 is removable from the storage module 300. The second coupling head 326 may protrude out from the gearbox 324 and rotate independently of the gear housing of the gearbox 324. The gear housing of the gearbox 324 may be formed by an upper part 332 and a lower part 334. The upper housing part 332 and/or lower housing part 334 may be used to fix the gearbox 324 to the storage module 300. For example, the gearbox 324 may be fastened to the main body 302 and/or the inner liner 314. The upper housing part 332 and/or lower housing part 334 may also be used to fix the gearbox 324 to the receiving coupler 322. In some embodiments, the second coupling head 326 may further drive one or more gears in the gear box 324.

In some embodiments, the gearbox 324 may contain a transmission gear 328 engaging another gear 330. For example, the gear 328 may be a pinion gear and the gear 330 may be an internal ring or annular gear, with the pinion gear 328 disposed on the toothed inner diameter of the annular gear 330. The pinion gear 328 is connected to the second coupling head 326 in a shaft-locked manner, either integrally or through attachment means. The annular gear 330 is fixed with respect to the receiving coupler 322. In some embodiments, a lower portion of the annular gear 330 may extend from the annular gear region of the annular gear 330, and the receiving coupler 322 may be fixed to this lower extension portion of the annular gear 330. In such a drivetrain configuration: the first motor 220 drives the first coupling head 224; the first coupling head 224 drives the second coupling head 326; the second coupling head 326 drives the pinion gear 328; the pinion gear 328 drives the annular gear 330; and the annular gear 330 drives the receiving coupler 322. The driven receiving coupler 322 rotates relative to the storage module 300, in particular the ingredient cavities 310.

In some embodiments, the receiving coupler 322 may include a threaded portion configured to engage with a corresponding threaded portion of the retention coupler 354. The disc 350, via the retention coupler 354, may be securely fastened to the receiving coupler 322 with this screw connection. In turn, the disc 350 may be controllably rotated by the first motor 220. Securing the disc 350 to the receiving coupler 322 facilitates the transfer of rotational motion from the first motor 220 to the disc 350. Further, in such embodiments, the disc 350 may be reversibly secured with respect to the modules 200, 300, which allows convenient disassembly for maintenance, cleaning, and the like. When secured, the first motor 220 may controllably rotate the disc 350 to dispense the desired ingredients from the corresponding cavity 310 based on the instructions from the controller 624. The transmission assembly 340, which includes the receiving coupler 322 and the gearbox 324, may comprise an annular shape defining an axial passage or opening 342 extending therethrough to accommodate the shaft 230. Further, the transmission gear 328 may be laterally offset from the shaft 230. The disc 350 and the retention coupler 354 may also comprise an annular shape such that the passage 342 is also formed therethrough.

In the second motor assembly, the second motor 222 is operatively coupled to the shaft 230 in a fixed manner. In some embodiments, the second motor 222 may be coupled to a first gear 226 which engages with a second gear 228 coupled to the shaft 230, thereby allowing the second motor 222 to rotate the shaft 230. In such a drivetrain configuration: the second motor 222 drives the first gear 226; the first gear 226 drives the second gear 228; and the second gear 228 drives the shaft 230. The driven shaft 230 rotates relative to the storage module 300.

The shaft 230 may extend out of the motor module 200 for mounting the tool 400 thereon. The shaft 230 may be arranged in the axial passage 342 which extends through the gearbox 324 and the receiving coupler 322, as well as the disc 350 and the retention coupler 354. In some embodiments, the axial passage 342 is dimensioned to provide a clearance gap in the radial direction to prevent the shaft 230 from coming into contact with components of the first motor assembly, and vice versa. In other embodiments, the shaft 230 may be rotatably supported on one or more components of the first motor assembly with bearings, such as ball bearings for example. In such embodiments, the bearings may allow the shaft 230 to rotate freely within and independently of the transmission assembly 340.

The shaft 230 may be coupled to the motor module 200 on a first end, and to the tool 400 on a second end opposite to the first end. The tool 400 may be attached to the shaft 230 in a shaft-locked manner, such that mechanical motion from the second motor 222 is transferred from the shaft 230 to the tool 400. In some embodiments, the second end of the shaft 230 may extend downwardly out through at least the annular region of the receiving coupler 322. Preferably, the second end of the shaft 230 is readily accessible to the user to allow for convenient removal, attachment, and/or replacement of the tool 400 on the shaft 230.

In operation, the cooking apparatus 10 may function as a cohesive unit, with power and communication signals flowing seamlessly between its components. The base heating module 600 may be connected to an external power source or battery to receive power therefrom. When the storage module 300 is securely coupled to the base module 600, electrical connectivity is established through coupling of the electrical contacts of the connectors 308, 608 integrated into the engaging first and second handles 304, 604 (such as through the mechanical connectors 306, 606 thereof), which together form the handle assembly 50. This electrical connection allows power to be transferred from the base module 600 to the storage module 300. The electrical connection may also allow informational and operational signals (e.g., control instructions, parameter/sensor data, etc.) to be communicated from the controller 624 (which in turn may receive inputs from the computing device) and back to the controller 624 (which in turn may transmit outputs to the computing device). Further, power and signals may be then conveyed to the motor module 200, housed within the storage module 300, through coupling of the electrical contacts of the connectors 208, 318. The motor control circuit board 218 within the motor module 200 may interpret the instructions received from the controller 624, located in the base module 600, and/or divert power to the motors 220, 222 as needed. The instructions may indicate the speed, direction, torque, rate (in terms of intervals), positions, and the like, according to which either the disc 350 and/or the tool 400 coupled to the motor module 200 is to be moved. Based on these instructions, the first motor 220 may be activated to drive the disc 350. The first coupling head 224 of the first motor 220, engaging with the second coupling head 326 on the gearbox 324, initiates the actuation. The rotation of the second coupling head 326 is then transferred through the pinion gear 328 to the annular gear 330, causing the receiving coupler 322, and consequently the disc 350 mounted thereon, to rotate. Independently and/or simultaneously, the second motor 222, controlled by the same or different set of instructions, may drive the shaft 230 via the intermeshing gears 226, 228, transferring motion to the attached tool 400. This synchronized operation allows for controlled dispensing of ingredients from the storage module 300 and their concurrent processing within the cooking pot 500.

In some embodiments, the motor module 200 may include one or more anti-vibration pads 232 configured to absorb and dampen vibrations generated by the motors 220, 222 during operation. This may reduce noise and mechanical stress on the motor module 200, enhancing durability and user comfort. The one or more anti-vibration pads 232 may be arranged between the motors 220, 222 and a supporting surface of motor module 200, on which the motors 220, 222 are supported in the main body 202.

In some embodiments, the motor module 200 may be configured to receive power and/or operational instructions from the controller 624. As stated, the motor module 200 may be electrically connected to the storage module 300 (which may in-turn be connected to the base module 600) through the electrical contacts, such as those of the electrical connector 208 disposed on the extension member 204 for example. The electrical contacts may be communicatively connected with the motor control circuit board 218 of the motor module 200. The circuit board 218 may include electronic components and circuitry required for power distribution to the motors 220, 222, encoding/decoding electrical signals, interpreting and processing instructions from the controller 624, and/or otherwise controlling functions of the motor module 200. The circuit board 218 may also be configured to communicate data back to other components of the cooking apparatus 10. For example, the circuit board 218 may receive, process, and transmit data collected by one or more sensors. In particular, the motor module 200 preferably includes a position or proximity sensor 234 (see FIG. 5D) to determine the positional orientation of the ingredient dispensing disc 350, and therefore, the cavity 310 under which the disc opening 352 is located. In some embodiments, the sensor 234 may be a Hall effect sensor configured to detect magnets 336 mounted on a rotating component of the first motor assembly. For example, the magnets 336 may be arranged in the gearbox 324, such as on the annular gear 330 for example. The sensor 234 detects magnetic field changes caused by the rotating magnets 336 passing by the stationary sensor 234. Each magnet 336 may correspond to one of the cavities 310. Therefore, each time the sensor 234 detects the passage of a magnet 336 corresponds to the disc opening 352 being moved to another cavity 310. In this way, the location of the disc opening 352 may be monitored, tracked, and adjusted according to the particular cooking process being executed by the controller 624. The sensor 234 may also be configured to detect a rotational speed of the disc 350.

In some embodiments, the cooking apparatus 10 may be implemented as a pressure cooker to reduce cooking time and enhance flavor infusion of the ingredients in the cooking pot 500. In some embodiments, the cooking apparatus 10 may include a cold storage system to maintain the ingredients at a predefined temperature for extended periods of time. In some embodiments, the cooking apparatus 10 may include a sous-vide cooking module that facilitates precise temperature control in the cooking pot 500 to cook ingredients evenly and retain moisture.

In some embodiments, the cooking apparatus 10 may be integrated with one or more sensors to detect and identify one or more process parameters within the cooking pot 500, and automatically adjust cooking settings for optimal results. The parameters may include, but are not limited to, temperature, pressure, humidity, water level, tool speed, and the like.

In some embodiments, the cooking apparatus 10 may be configured with an artificial intelligence (AI)-powered system that suggests recipes based on available ingredients, dietary preferences, and previous cooking history corresponding to a user. In some embodiments, the AI-powered system learns from user behavior and preferences over time, adjusting cooking methods and times to better suit individual tastes. In some embodiments, the AI-powered system may provide cooking tips, suggest recipe variations, and assist in planning and preparation of the food.

In some embodiments, the cooking apparatus 10 may be configured with voice control systems for hands-free operation and voice-command cooking instructions. In some embodiments, the cooking apparatus 10 may be configured with an augmented reality (AR) cooking guide that guides users through the cooking process step-by-step, overlaying instructions and tips directly onto the cooking environment through the computing device, for example, but not limited to, smart phones or AR glasses.

In some embodiments, the cooking apparatus 10 may be configured with a nutritional analysis module to facilitate real-time nutritional analysis of the food being cooked, helping users to track their dietary intake. In some embodiments, the cooking apparatus 10 may include multiple zones to cook multiple dishes simultaneously in separate compartments, each with independent temperature and cooking settings. Accordingly, it may be appreciated that while a certain number of components are depicted in the figures, any number of the components may be implemented in the cooking apparatus 10 within the scope of the disclosure.

In some embodiments, the cooking apparatus 10 may include an automated cleaning module that uses, for example, steam and ultrasonic waves to clean the cooking compartments after use. In some embodiments, the cooking apparatus 10 may be integrated with a meal planning system that helps users to organize their weekly meals, automatically generating shopping lists and synchronizing with grocery delivery services.

In some embodiments, users may create and save custom cooking profiles of their favorite recipes in the cooking apparatus 10 and/or the operable software application on the associated computing device, allowing for easy replication of specific cooking techniques and settings. The power consumption during the cooking process may be optimized, making the cooking apparatus 10 eco-friendly. In some embodiments, the cooking apparatus 10 may be associated with a user platform where users can connect and share recipes, cooking tips, and experiences relating to the cooking apparatus 10. The user platform may provide instructions and interface options in multiple languages to cater to a global user base. According to some embodiments, the user platform may be integrated into the operable software application of the cooking apparatus 10.

In some embodiments, the cooking apparatus 10 may include a food management module that tracks usage of the ingredients or the food components and provides one or more recommendations to the user to minimize waste, promoting sustainability. In some embodiments, the food management module may provide customizable diet and meal plans based on user health data, dietary preferences, and goals, with automatic adjustments and recommendations. In some embodiments, the food management module may automatically adjust the recipes and quantities of the ingredients based on a number of servings required, avoiding wastage of the food.

In some embodiments, the cooking apparatus 10 may include a tracking module that tracks and maintains a digital record of the ingredients, suggests recipes based on available ingredients, and generates shopping lists for depleted stocks. In some embodiments, the tracking module may track environmental impact of the food, such as carbon footprint and water usage, helping users to make more sustainable cooking choices.

In some embodiments, the cooking apparatus 10 may include an automated ingredient dispensing module that automatically dispenses the ingredients at specific times during the cooking process to ensure perfect timing and consistency.

In some embodiments, the cooking apparatus 10 may be integrated with online grocery services to automatically reorder the ingredients as they are used, ensuring a constant supply of fresh ingredients.

In some embodiments, the cooking apparatus 10 may be integrated with a safety mechanism that automatically shuts off the cooking apparatus 10 in case of overheating, power surges, or other potential hazards. The safety mechanism may include a lock to prevent accidental operation by children or any unauthorized user(s).

In some embodiments, the cooking apparatus 10 may be integrated with a built-in scanner that identifies the ingredients and suggests the recipes based on the available ingredients. In some embodiments, the cooking apparatus 10 may be integrated with a display module configured to display high-quality images and videos for each step of the recipe, making it easier for users to follow during the cooking process.

In some embodiments, the cooking apparatus 10 may be configured with a weighing and dispensing module that automatically measures the ingredients during meal preparation, and dispenses an accurate amount of the ingredients into the cooking pot 500, thereby ensuring precision in the cooking process. In some embodiments, the cooking apparatus 10 may be integrated with ovens, thereby allowing for quick meal preparation without a need for a pressure cooker. In some embodiments, the cooking apparatus 10 may be configured with one or more cameras for live viewing and AI-based cooking monitoring to ensure precision and quality. In some embodiments, the cooking apparatus 10 may be configured with in-built with power storage devices, such that the cooking apparatus 10 may be utilized anywhere, for example, while traveling.

Therefore, the disclosed cooking apparatus 10 may be simple, compact, easy to maintain, and user-friendly. The cooking apparatus 10 may be easy to clean with a dishwasher-friendly lid 100, storage module 300, dispensing disc 350, cooking pot 500, and tool attachments 400. The tool 400 may be removable, and replaceable with other tools used to process the ingredients dispensed into the cooking pot 500 differently, based on the requirements of the particular use case. The cooking apparatus 10 may also include accessory stainless steel sleeves for holding ingredients in the cavities 310, ensuring that the ingredients do not contact plastic. The compact design of the cooking apparatus 10 may facilitate automatic cooking at home and other places, and reduce manufacturing costs. Additionally, a single motor module 200 may be used to drive multiple components independently and/or concurrently, based on the requirements and/or constraints.

Furthermore, the cooking apparatus 10 may be conveniently disassembled. For example, the user may decouple the storage module 300 from the base module 600 by lifting the storage module 300 off the base module 600. Such disassembly may provide the user with access to the contents of the cooking pot 500. The cooking pot 500 may also be removed from the base module 600 for serving the ingredients cooked therein, and for cleaning. The user may also conveniently detach the tool attached to the bottom of the motor module 200. Where the tool 400 is preferably attached using magnetic coupling means, the tool 400 may be easily and readily detached without further equipment or significant effort. The storage module 300, once detached from the base module 600 and the motor module 200 is removed therefrom, may be washed in a dishwasher. The dispensing disc 350, or dispensing disc assembly 350, may be easily and readily attached to, and detached from, the storage module 300 via a screw connection between the receiving coupler 322 and the retention coupler 354. The dispensing disc 350, or dispensing disc assembly 350, may then also be placed in the dishwasher for washing. Since the electrical connections between the modules 200, 300, 600 are preferably formed by electrical contacts (such as contact pins), the assembly and disassembly of the modules 200, 300, 600 does not require further tools or significant effort in terms of connecting, disconnecting, and reconnecting the electrical connections between the modules 200, 300, 600. In some embodiments, the storage module 300 may be also placed in a refrigerator, such as for preservation of ingredients being stored therein.

Although the disclosure shows and describes exemplary components of the cooking apparatus 10, in other embodiments, the cooking apparatus 10 may include fewer components, different components, differently arranged components, or additional functional components than shown and described in the disclosure. Additionally, or alternatively, one or more components of the cooking apparatus 10 may perform functions described as being performed by one or more other components of the cooking apparatus 10.

Although the disclosure has been shown and described with respect to one or more implementations, equivalent alterations and modifications will occur to others skilled in the art based upon a reading and understanding of this specification and the drawings. The disclosure includes all such modifications and alterations. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

The skilled person will be aware of a range of possible modifications, permutations, additions, and combinations of the various aspects and embodiments described above, without these needing to be specifically explained or shown within the context of this disclosure. Accordingly, the present disclosure is defined by the claims and their equivalents. The claims should therefore be interpreted to include all such modifications, permutations, and additions within their true spirit and scope. Each embodiment described herein has numerous equivalents.

1. A cooking apparatus comprising:
a base heating module and an ingredient storage module operatively mountable above the base heating module, wherein the base heating module comprises a heating element for heating a cooking pot, and wherein the ingredient storage module comprises a plurality of compartments circumferentially arranged for holding ingredients, and a center cavity configured to accommodate a motor module therein,
the motor module comprises a first motor and a second motor, wherein the first motor is configured to rotate a dispensing disc relative to the plurality of compartments, with the dispensing disc having an opening for selectively dispensing ingredients from the plurality of compartments into the cooking pot, and wherein the second motor is configured to rotate a tool to process ingredients in the cooking pot.

2. The cooking apparatus of claim 1, further comprising a controller configured to execute a set of processor-executable instructions to control the motor module and the heating element according to a selected cooking process.

3. The cooking apparatus of claim 2, further comprising a first sensor configured to detect rotation of the dispensing disc in relation to the plurality of compartments during the cooking process, and a second sensor configured to monitor a cooking temperature during the cooking process, wherein first and second sensors are communicatively connected to the controller, and wherein the controller controls the motor module and the heating element based on data from the first and second sensors.

4. The cooking apparatus of claim 1, wherein the ingredient storage module comprises a first handle portion and the base heating module comprises a second handle portion, wherein the first and second handle portions comprise respective mechanical connectors with interlocking elements configured to engage with each other to form a handle assembly of the cooking apparatus.

5. The cooking apparatus of claim 4, wherein the first and second handle portions further comprise respective electrical contact connectors configured to engage with each other to electrically connect the ingredient storage module and the base heating module when the ingredient storage module is mechanically coupled to the base heating module.

6. The cooking apparatus of claim 1, wherein the motor module is removably disposed in the ingredient storage module.

7. The cooking apparatus of claim 6, wherein the motor module comprises a first electrical contact connector configured to engage a second electrical contact connector of the ingredient storage module to form an electrical connection therebetween.

8. The cooking apparatus of claim 7, wherein the motor module comprises an extension member which projects laterally outward from an upper end section of the motor module, wherein the first electrical contact connector is arranged in the extension member, and wherein the second electrical contact connector is arranged in an upper end section of the ingredient storage module between two adjacent compartments of the plurality of compartments.

9. The cooking apparatus of claim 7, wherein the base heating module and the ingredient storage module are electrically connected to one another, and the motor module is configured to receive power and/or instructions from a controller in the base heating module through the ingredient storage module.

10. The cooking apparatus of claim 1, wherein the cooking pot is removably supported on the base heating module above the heating element and thermally insulated from other portions of the base heating module.

11. The cooking apparatus of claim 1, wherein the plurality of compartments are accessible from above for loading ingredients therein, and open downwardly toward the dispensing disc.

12. The cooking apparatus of claim 11, wherein one or more compartments of the plurality of compartments have an inverted V-shaped profile configured to prevent ingredients from adhering to surfaces of the one or more compartments.

13. The cooking apparatus of claim 1, wherein the dispensing disc has a retention coupler configured to engage a receiving coupler of the ingredient storage module, and the receiving coupler is rotatably disposed on the ingredient storage module.

14. The cooking apparatus of claim 13, wherein the receiving coupler and the retention coupler have complementary threaded portions configured to form a screw connection.

15. The cooking apparatus of claim 13, wherein the receiving coupler is fixed relative to an annular gear configured to engage a transmission gear driven by the first motor, with the transmission gear laterally offset from a shaft extending from the motor module, the shaft operatively coupled to the second motor, and wherein the shaft is arranged in a passage through the annular gear.

16. The cooking apparatus of claim 15, wherein the tool is removably attached to an end of the shaft opposite the motor module.

17. A cooking apparatus comprising:
a base heating module having a heating element for heating a cooking pot,
an ingredient storage module operatively mountable above the base heating module, wherein the ingredient storage module comprises a plurality of compartments circumferentially arranged for holding ingredients, and a center cavity configured to accommodate a motor module therein,
wherein an ingredient dispensing disc is rotatably connected to the ingredient storage module below the plurality of compartments, and the ingredient dispensing disc has an opening for selectively dispensing ingredients from the plurality of compartments, and
wherein at least one handle assembly is formed by a first handle portion of the ingredient storage module and a second handle portion of the base heating module when the ingredient storage module is mounted on the base heating module, wherein the handle assembly mechanically couples the ingredient storage module to the base heating module, and wherein the at least one handle assembly forms an electrical connection for transmitting power and/or instructions between the ingredient storage module and the base heating module.

18. The cooking apparatus of claim 17, wherein interlocking elements of the first and second handle portions comprise electrical contact connectors configured to engage with each other to form the electrical connection between the base heating module and the ingredient storage module.

19. The cooking apparatus of claim 17, wherein the motor module is removably disposed in the ingredient storage module, and wherein the ingredient storage module and the motor module comprise electrical contact connectors configured to engage with each other to form an electrical connection for transmitting power and/or instructions between the ingredient storage module and the motor module.

20. The cooking apparatus of claim 19, wherein the motor module comprises a first motor configured to rotate the dispensing disc relative to the plurality of compartments, and a second motor configured to rotate a tool to process ingredients in the cooking pot, according to the instructions transmitted through the ingredient storage module from a controller in the base heating module.
